(19) United States
(12) Patent Application Publication
(10) Pub. No.: US 2015/0332805 A1
(43) Pub. Date: Nov. 19, 2015

(54) ELECTRODE COMPOSITIONS AND ENERGY STORAGE DEVICES

(71) Applicant: E I DU PONT DE NEMOURS AND COMPANY, Wilmington, DE (US)

(72) Inventors: MICHAEL JOSEPH BROWN, Wilmington, DE (US); Biswajit Choudhury, Wilmington, DE (US); Mookkan Periyasamy, Wilmington, DE (US); Ronald Earl Uschold, West Chester, PA (US)

(21) Appl. No.: 14/703,014

(22) Filed: May 4, 2015

Related U.S. Application Data
(60) Provisional application No. 61/994,317, filed on May 16, 2014.

(51) Int. Cl. H01B 1/20; H01M 2/16; H01M 10/0525; H01G 9/042; H01M 4/62

(52) U.S. Cl. CPC H01B 1/20; H01G 9/042; H01M 4/623; H01M 10/0525; H01M 2/1673

(57) ABSTRACT

In a first aspect, an electrode composition includes an electroactive material and an interpolymer including polymer units derived from about 64 to about 75 mole percent vinyl fluoride and from about 25 to about 36 mole percent of at least two highly fluorinated monomers. A first highly fluorinated monomer provides the interpolymer a side chain of at least one carbon atom.

In a second aspect, an energy storage device includes an anode, a cathode, a porous separator between the anode and the cathode and an electrolyte. The anode, the cathode or both the anode and the cathode include a binder material including an interpolymer including polymer units derived from about 64 to about 75 mole percent vinyl fluoride and from about 25 to about 36 mole percent of at least two highly fluorinated monomers. A first highly fluorinated monomer provides the interpolymer a side chain of at least one carbon atom.

### BACKGROUND INFORMATION

1. Field of the Disclosure

This disclosure is in the field of fluoride interpolymers, electrode compositions and energy storage devices.

2. Description of the Related Art

Lithium-ion batteries (LIBs) are commonly used as a rechargeable energy source in consumer electronics, and are even beginning to be used in some electric vehicle applications. The need for high-voltage lithium-ion batteries (HV-LIBs), however, is becoming increasingly important for the future development of electric vehicles, including hybrid electric vehicles and plug-in hybrid vehicles. High-voltage applications are more demanding on batteries, requiring a higher power/energy density, while maintaining a long cycle life. In addition, enhancing safety under normal and abusive operating conditions and lowering manufacturing costs are also needed for the success of HV-LIBs. One way to increase the energy density of a battery is to use cathode materials capable of operating at voltages (V) of up to 5.0 V (vs. Li/Li⁺). The use of such high-voltage cathodes, however, poses very stringent requirements for the electrochemical stability of other components in the battery, such as the electrolyte, electrode binder material and electrolyte additives. In conventional LIBs, which typically operate in the range of 3.7 to 4.2 V (vs. Li/Li⁺), polyvinylidene fluoride (PVDF) may be used as a polymer binder material for both positive and negative electrodes. PVDF has strong binding strength and low flexibility, is suitable for electrode casting and performs well during charge/discharge cycling in this operating range. However, the electrochemical stability of PVDF is only about 4.7 V (vs. Li/Li⁺), which makes PVDF unsuitable as a binder material in high-voltage battery applications.

Polyvinyl fluoride (PVF) has been manufactured for many years and has found many uses as a film or coating over a variety of substrates. For example, PVF has been incorporated into backsheets for photovoltaic modules, where it provides superior weatherability, mechanical, electrical and barrier properties. PVF homopolymer is not soluble in conventional solvents, however, so films or coatings of PVF are typically made from dispersions of PVF in latent solvents, from which a film or coating is coalesced. Recently, vinyl fluoride copolymers and vinyl fluoride interpolymers with low crystallinity have been described by Uschold in U.S. Pat. No. 6,242,547 (2001), U.S. Pat. No. 6,271,303 (2001), and U.S. Pat. No. 6,403,740 (2002). Uschold, in U.S. Pat. No. 6,242,547, proposes an interpolymer comprised of VF and at least two highly fluorinated monomers wherein at least one of the highly fluorinated monomers introduces a side chain, having at least one carbon atom, into the polymer. Such an interpolymer dissolves easily in some organic solvents because of decreased crystallinity.

There is a need for polymer binder materials with higher electrochemical stability that may be used in higher voltage electrochemical applications.

### SUMMARY

In a first aspect, an electrode composition includes an electroactive material and an interpolymer including polymer units derived from about 64 to about 75 mole percent vinyl fluoride and from about 25 to about 36 mole percent of at least two highly fluorinated monomers. A first highly fluorinated monomer provides the interpolymer a side chain of at least one carbon atom.

In a second aspect, an energy storage device includes an anode, a cathode, a porous separator between the anode and the cathode and an electrolyte. The anode, the cathode or both the anode and the cathode include a binder material including an interpolymer including polymer units derived from about 64 to about 75 mole percent vinyl fluoride and from about 25 to about 36 mole percent of at least two highly fluorinated monomers. A first highly fluorinated monomer provides the interpolymer a side chain of at least one carbon atom.

The foregoing general description and the following detailed description are exemplary and explanatory only and are not restrictive of the invention, as defined in the appended claims.

### DETAILED DESCRIPTION

### Definitions

The following definitions are used herein to further define and describe the disclosure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the terms “a” and “an” include the concepts of “at least one” and “one or more than one”.

Unless stated otherwise, all percentages, parts, ratios, etc., are by weight.

When the term “about” is used in describing a value or an end-point of a range, the disclosure should be understood to include the specific value or end-point referred to.

In a first aspect, an electrode composition includes an electroactive material and an interpolymer including polymer units derived from about 64 to about 75 mole percent vinyl fluoride and from about 25 to about 36 mole percent of at least two highly fluorinated monomers. A first highly fluorinated monomer provides the interpolymer a side chain of at least one carbon atom.

In one embodiment of the first aspect, a second highly fluorinated monomer includes a C₂ olefin. In a specific embodiment, the C₂ olefin is selected from the group consisting of vinylidene fluoride, tetrafluoroethylene, trifluoroethylene, and chlorotrifluoroethylene. In a more specific embodiment, the C₂ olefin includes tetrafluoroethylene.

In another embodiment of the first aspect, the first highly fluorinated monomer includes hexafluoropropylene.

In still another embodiment of the first aspect, the interpolymer includes from about 6 to about 10 mole percent of the first highly fluorinated monomer.

In yet another embodiment of the first aspect, the interpolymer includes less than about 30 mole percent of the second highly fluorinated monomer.

In still yet another embodiment of the first aspect, the electroactive material includes an electroactive cathode material.

In a further embodiment of the first aspect, the electroactive material includes an electroactive anode material.

In still a further embodiment of the first aspect, the electrode composition further includes a conductive additive material.

In yet a further embodiment of the first aspect, the electrode composition includes less than 10 weight percent interpolymer.

In still yet a further embodiment of the first aspect, the electrode composition further includes polyvinylidene fluoride.

In a second aspect, an energy storage device includes an anode, a cathode, a porous separator between the anode and the cathode and an electrolyte. The anode, the cathode or both the anode and the cathode include a binder material including an interpolymer including polymer units derived from about 64 to about 75 mole percent vinyl fluoride and from about 25 to about 36 mole percent of at least two highly fluorinated monomers. A first highly fluorinated monomer provides the interpolymer a side chain of at least one carbon atom.

In one embodiment of the second aspect, a second highly fluorinated monomer includes a C₂ olefin. In a specific embodiment, the C₂ olefin is selected from the group consisting of vinylidene fluoride, tetrafluoroethylene, trifluoroethylene, and chlorotrifluoroethylene. In a more specific embodiment, the C₂ olefin includes tetrafluoroethylene.

In another embodiment of the second aspect, the first highly fluorinated monomer includes hexafluoropropylene.

In yet another embodiment of the second aspect, the energy storage device operates at a voltage of at least 3.7 volts. In a specific embodiment, the energy storage device operates at a voltage of at least 4.2 volts. In a more specific embodiment, the energy storage device operates at a voltage of at least 4.7 volts.

In still yet another embodiment of the second aspect, the energy storage device includes a lithium-ion battery.

Many aspects and embodiments have been described above and are merely exemplary and not limiting. After reading this specification, skilled artisans appreciate that other aspects and embodiments are possible without departing from the scope of the invention. Other features and advantages of the invention will be apparent from the following detailed description, and from the claims.

### Soluble Vinyl Fluoride Interpolymers

The present invention is directed to terpolymers and higher soluble interpolymers, consisting essentially of units derived from vinyl fluoride and at least two highly fluorinated monomers, at least one of the highly fluorinated monomers introducing into the polymer a side chain of at least one carbon atom. For the purposes of the present invention, “consists essentially of” means that, while the soluble interpolymer may contain other monomer units, the significant properties of the soluble interpolymer are determined by the named monomer units. In one embodiment, a soluble interpolymer composition comprises from about 64 to about 75 mol % vinyl fluoride and from about 25 to about 36 mol % of at least two highly fluorinated monomers. In one embodiment, a first highly fluorinated monomer introduces into the interpolymer a side chain of at least one carbon atom. In another embodiment, a second highly fluorinated monomer comprises a C₂ olefin. In a specific embodiment, a C₂ olefin is selected from the group consisting of vinylidene fluoride, tetrafluoroethylene, trifluoroethylene, and chlorotrifluoroethylene.

In one embodiment, a first highly fluorinated monomer, which introduce into the interpolymer a side chain of at least one carbon atom, includes perfluoroolefins having 3 to 10 carbon atoms, highly fluorinated olefins such as CF₃CY═CY₂ where Y is independently H or F, perfluoroC₁-C₈alkyl ethylenes, fluorinated dioxoles, and fluorinated vinyl ethers of the formula CY₂═CYOR or CY₂═CYOR′OR wherein Y is H or F, and R and —R′ are independently completely-fluorinated or partially-fluorinated alkyl or alkylene group containing 1 to 8 carbon atoms, and in some embodiments are perfluorinated. In one embodiment, R groups contain 1 to 4 carbon atoms, and in some embodiments are perfluorinated. In one embodiment, R′ groups contain 2 to 4 carbon atoms, and in some embodiments are perfluorinated. In one embodiment, Y is F. For the purposes of the present disclosure, highly fluorinated is intended to mean that 50% or greater of the atoms bonded to carbon are fluorine, excluding linking atoms such as O or S.

In some embodiments, first highly fluorinated monomers are perfluoroolefins, such as hexafluoropropylene (HFP); partially hydrogenated propenes such as 2,3,3,3-tetra perfluoropropene and 1,3,3,3-tetrafluoropropene; perfluoroC₁-C₈alkyl ethylenes, such as perfluorobutyl ethylene (PFBE); or perfluoro(C₁-C₈alkyl vinyl ethers), such as perfluoro(ethyl vinyl ether) (PEVE). Fluorinated dioxole monomers include perfluoro-2,2-dimethyl-1,3-dioxole (PDD) and perfluoro-2-methylene-4-methyl-1,3-dioxolane (PMD). Hexafluoroisobutylene is another highly fluorinated monomer useful in some embodiments.

In some embodiments, soluble interpolymers are substantially random interpolymers. The substantially random character of the polymer is indicated by nuclear magnetic resonance spectroscopy.

By adding a termonomer having a side chain of at least one carbon atom, polymer compositions exhibit lower melting points and heats of fusion than unmodified compositions. Bulky side groups on the terpolymer hinder formation of a crystalline lattice structure. For example in comparing modified terpolymers to copolymers such as VF/TFE where the copolymer and the terpolymer have the same [VF]/[TFE] ratio, reduced crystallinity of the terpolymer is observed. As a consequence, films made from terpolymers disclosed herein have substantially reduced haze.

Vinyl fluoride interpolymers can be produced in aqueous or nonaqueous media using the initiators, reaction temperatures, reaction pressures. In one embodiment, the soluble vinyl fluoride interpolymers disclosed herein can be produced in a process which introduces ionic end groups into the polymer. The soluble interpolymers with such end groups are advantageously prepared by polymerizing VF and a fluorinated monomer in water with a water-soluble free-radical initiator at a temperature in the range of from about 60 to about 100° C., or about 80 to about 100° C., and a reactor pressure in the range of from about 1 to about 12 MPa (about 145 to about 1760 psi), or about 2.1 to about 8.3 MPa (about 305 to about 1204 psi), or about 2.8 to about 4.1 MPa (about 406 to about 595 psi). In one embodiment, the polymerization can be carried out in a horizontal autoclave. In another embodiment, the polymerization can be carried out in a vertical autoclave.

The initiators form ions upon dissolution in aqueous medium, and they introduce ionic end groups into the terpolymers produced. These end groups are derived from initiator fragments which begin the polymerization process. The amount of ionic end groups present in the polymer product is generally not more than 0.05 weight %. Small spherical particles may be formed that remain well dispersed in water because of the electrostatic charge on the particle surface arising from the ionic end groups. The electrostatic charge on the particles causes them to repel one another and keeps them suspended in water producing low viscosity terpolymer lattices. As a consequence, the lattices are fluid and stable enough to be pumped through equipment, making the polymerization process easy to operate and control, and produce aqueous dispersions of the soluble interpolymers. In one embodiment, the viscosity of the dispersions is less than 500 centipoises (0.5 Pa·s). In one embodiment, compositions comprise from about 5 to about 40%, or about 15 to about 30% by weight of terpolymer and about 60 to about 95%, or about 70 to about 85% by weight of water. Such dispersions can be made more concentrated if desired using techniques which are known in the art.

Initiators useful in manufacturing soluble interpolymer disclosed herein are water-soluble free-radical initiators such as water-soluble organic azo compounds such as azoamidine compounds which produce cationic end groups or water-soluble salts of inorganic peracids which produce anionic end groups. In one embodiment, organic azoamidine initiators include 2,2′-azobis(2-amidinopropane)dihydrochloride and 2,2′-azobis(N,N′-dimethyleneisobutyroamidine)dihydrochloride. In one embodiment, water-soluble salts of inorganic peracids include alkali metal or ammonium salts of persulfate.

For example, 2,2′-azobis(2-amidinopropane)dihydrochloride produces a terpolymer with an amidinium ion as an end group and yields terpolymer particles with a positive or cationic charge. Similarly, 2,2′-azobis(N,N′-dimethyleneisobutyroamidine)dihydrochloride produces a terpolymer with an N,N′-dimethyleneamidinium ion as an end group and yields positively charged or cationic particles. Persulfate initiators place sulfate end groups on the interpolymers which yield negatively charged or anionic particles.

Optionally, as well known to those skilled in the art of emulsion polymerization, additional ingredients may be added to the polymerization medium to modify the basic emulsion process. For example, surfactants compatible with the end groups of the polymer are advantageously employed. For instance, perfluorohexylpropylamine hydrochloride is compatible with the cationic end groups present in polymer initiated by bisamidine dihydrochloride; or ammonium perfluorooctanoate or perfluorohexylethane sulfonic acid or its salts can be used with the polymer having anionic end groups initiated by persulfate salts. As known in the art, reducing agents such as bisulfites, sulfites and thiosulfates can be used with persulfates to lower initiation temperatures or modify the structure of the polymer ionic end group. Buffering agents, such as phosphates, carbonates, acetates and the like, can be used with persulfate initiators to control latex pH. In some embodiments, initiators are the azobisamidine dihydrochlorides and ammonium persulfate used in combination with a surfactant, since they produce the whitest terpolymers and permit high aqueous dispersion solids.

The presence of the amidine hydrochloride end groups in the terpolymers disclosed herein is evident from their infrared spectra. The amidine hydrochloride end group in 2,2′-azobis(2-amidinopropane)dihydrochloride absorbs at 1680 cm⁻¹. The presence of this end group in the terpolymers is confirmed by the appearance of a band in their infrared spectra at 1680 cm 1. Carboxyl and hydroxyl end groups are produced in polymers made with persulfate by hydrolysis of the sulfate end groups to yield fluoroalcohols that spontaneously decompose to form carboxylic end groups, or non-fluorinated alcohols if the sulfate end group happens to be on a non-fluorinated carbon. The presence of these end groups is observed by bands in the infrared spectrum of these polymers at 1720 cm⁻¹ and 3526 cm⁻¹ for the carbonyl and hydroxyl structures, respectively.

Polymers with nonionic phenyl end groups may produce interpolymer particles which vary in size from submicrometer to greater than 10 μm. The particles have irregular shapes and often contain channels and voids.

In one embodiment, soluble vinyl fluoride interpolymers may be soluble in a solvent selected from the group consisting of dimethyl acetamide (DMA), N-methyl pyrrolidone (NMP), dimethyl sulfoxide (DMSO), dimethyl formamide (DMF) and mixtures thereof. In a specific embodiment, soluble vinyl fluoride interpolymers may be soluble in N-methyl pyrrolidone.

### Polymer Binder Solutions and Electrode Compositions

In one embodiment, a polymer binder solution comprises a solvent selected from the group consisting of dimethyl acetamide, N-methyl pyrrolidone, dimethyl sulfoxide, dimethyl formamide and mixtures thereof and a vinyl fluoride interpolymer. In a specific embodiment, the solvent for the polymer binder solution comprises NMP. In one embodiment the polymer binder solution comprises less than about 15 weight percent vinyl fluoride interpolymer, or less than about 10 weight percent vinyl fluoride interpolymer, or less than about 5 weight percent vinyl fluoride interpolymer. In one embodiment, the polymer binder solution may include a blend of a vinyl fluoride interpolymer and an additional soluble polymer, such as a fluoropolymer, an ethylene copolymer, a polymethyl methacrylate or a polyimide In a specific embodiment, the additional soluble polymer may be polyvinylidene fluoride. In one embodiment, the polymer binder solution may be combined with other components to form an electrode precursor composition that may be used to make an electrode for an electrochemical device, such as a lithium-ion battery.

In one embodiment, the electrode precursor composition comprises an electroactive material. In one embodiment, the electroactive material is a electroactive cathode material. In a more specific embodiment, the electroactive cathode material is a high voltage electroactive material, capable of being charged to greater than about 4.1 (vs. Li/Li⁺) or about 4.2 (vs. Li/Li⁺), or about 4.3 (vs. Li/Li⁺), or about 4.35 (vs. Li/Li⁺), or about 4.4 (vs. Li/Li⁺), or about 4.5 (vs. Li/Li⁺), or about 4.6 (vs. Li/Li⁺), or about 4.7 (vs. Li/Li⁺), or about 4.8 V (vs. Li/Li⁺).

Suitable electroactive cathode materials for a lithium-ion battery include electroactive transition metal oxides comprising lithium, such as LiCoO₂, LiNiO₂, LiMn₂O₄, or LiV₃O₈; oxides of layered structure such as LiNiₓMn_{y}Co_{z}O₂ where x+y+z is about 1, LiCo_{0.2}Ni_{0.2}O₂, Li_{1+z}Ni_{1-x-y}CoₓAl_{y}O₂ where 0<x<0.3, 0<y<0.1, and 0<z<0.06, LiFePO₄, LiMnPO₄, LiCoPO₄, LiNi_{0.5}Mn_{1.5}O₄, LiVPO₄F; mixed metal oxides of cobalt, manganese, and nickel such as those described in U.S. Pat. No. 6,964,828 (Lu) and U.S. Pat. No. 7,078,128 (Lu); nanocomposite cathode compositions such as those described in U.S. Pat. No. 6,680,145 (Obrovac); lithium-rich layered-layered composite cathodes such as those described in U.S. Pat. No. 7,468,223; and cathodes such as those described in U.S. Pat. No. 7,718,319 and the references therein.

Another suitable electroactive cathode material is a lithium-containing manganese composite oxide having a spinel structure. A lithium-containing manganese composite oxide suitable for use herein comprises oxides of the formula LiₓNi_{y}M_{z}Mn_{2-y-z}O_{4-d}, wherein x is 0.03 to 1.0; x changes in accordance with release and uptake of lithium ions and electrons during charge and discharge; y is 0.3 to 0.6; M comprises one or more of Cr, Fe, Co, Li, Al, Ga, Nb, Mo, Ti, Zr, Mg, Zn, V, and Cu; z is 0.01 to 0.18; and d is 0 to 0.3. In one embodiment in the above formula, y is 0.38 to 0.48, z is 0.03 to 0.12, and d is 0 to 0.1. In one embodiment in the above formula, M is one or more of Li, Cr, Fe, Co and Ga. Stabilized manganese cathodes may also comprise spinel-layered composites which contain a manganese-containing spinel component and a lithium rich layered structure, as described in U.S. Pat. No. 7,303,840.

Other suitable electroactive cathode materials include layered oxides such as LiCoO₂ or LiNiₓMn_{y}Co_{z}O₂ where x+y+z is about 1, that can be charged to cathode potentials higher than the standard 4.1 to 4.25 V range in order to access higher capacity. Other examples are layered-layered high-capacity oxygen-release cathodes such as those described in U.S. Pat. No. 7,468,223 charged to upper charging voltages above 4.5 V.

In one embodiment, the electrode precursor composition further comprises a conductive additive material which improves the electrical conductivity of the electrode. In a specific embodiment, a conductive additive material may be carbon black, such as uncompressed carbon black.

In one embodiment, a cathode, comprising an electroactive cathode material, may be prepared by mixing the polymer binder solution with an effective amount of the cathode active material and the conductive additive material in a suitable solvent, such as NMP, to create a paste, which is then coated onto a current collector such as aluminum foil, and dried to form the cathode. The cathode can optionally be calendared after it is applied to the current collector.

In one embodiment, the electroactive material is an electroactive anode material. Suitable electroactive anode materials for a lithium-ion battery include lithium alloys such as a lithium-aluminum alloy, a lithium-lead alloy, a lithium-silicon alloy, a lithium-tin alloy and the like; carbon materials such as graphite and mesocarbon microbeads (MCMB); phosphorus-containing materials such as black phosphorus, MnP₄ and CoP₃; metal oxides such as SnO₂, SnO and TiO₂; nanocomposites containing antimony or tin, for example nanocomposite containing antimony, oxides of aluminum, titanium, or molybdenum, and carbon, such as those described by Yoon et al (Chem. Mater. 21, 3898-3904, 2009); and lithium titanates such as Li₄Ti₅O₁₂ and LiTi₂O₄. In one embodiment, the anode active material is lithium titanate or graphite.

An electrode precursor composition for an anode can be made by a method similar to that described above for a cathode wherein, for example, the polymer binder solution is mixed with an effective amount of the anode active material and a conductive additive material in a suitable solvent to obtain a paste. The paste is coated onto a metal foil, preferably aluminum or copper foil, to be used as the current collector. The paste is dried, preferably with heat, so that the active mass is bonded to the current collector. Suitable anode active materials and anodes are available commercially from companies such as Hitachi NEI Inc. (Somerset, N.J.), and Farasis Energy Inc. (Hayward, Calif.).

In one embodiment, an electrode composition can comprise from about 70 to about 98 weight percent electroactive material. In one embodiment, an electrode composition can comprise less than about 15 weight percent polymer binder material, or less than about 10 weight percent polymer binder material, or less than about 5 weight percent polymer binder material, or less than about 3 weight percent polymer binder material. In one embodiment, an electrode composition can comprise less than about 15 weight percent conductive additive material.

An electrochemical cell also contains a porous separator between the anode and cathode. The porous separator serves to prevent short circuiting between the anode and the cathode. The porous separator typically consists of a single-ply or multi-ply sheet of a microporous polymer such as polyethylene, polypropylene, polyamide or polyimide, or a combination thereof. The pore size of the porous separator is sufficiently large to permit transport of ions to provide ionically conductive contact between the anode and cathode, but small enough to prevent contact of the anode and cathode either directly or from particle penetration or dendrites which can from on the anode and cathode. Examples of porous separators suitable for use herein are disclosed in U.S. Patent Application Publication No. 2012/0149852.

An electrochemical cell further contains a liquid electrolyte comprising an organic solvent and a lithium salt soluble therein. The lithium salt can be LiPF₆, LiBF₄, or LiClO₄. Typically, the organic solvent comprises one or more alkyl carbonates. In a further embodiment, the one or more alkyl carbonates comprises a mixture of ethylene carbonate and dimethylcarbonate. The optimum range of salt and solvent concentrations may vary according to specific materials being employed, and the anticipated conditions of use; for example, according to the intended operating temperature. In one embodiment, the solvent is 70 parts by volume ethylene carbonate and 30 parts by volume dimethyl carbonate, and the salt is LiPF₆.

Soluble vinyl fluoride interpolymer may be used in a broad range of electrochemical applications. For example, soluble vinyl fluoride interpolymers may be used as an electrode binder for fabricating electrodes for an electrochemical energy storage device. The types of energy storage devices that can incorporate such an electrode include capacitors, flow-through capacitors, ultracapacitors, lithium-ion capacitors, lithium-ion batteries, fuel cells and hybrid cells which are the combination of the above devices. Soluble vinyl fluoride interpolymers may be used a polymer binder for both anodes and cathodes in these devices. In a particular application, soluble vinyl fluoride interpolymers may be used as a polymer binder in electrochemical applications that require an oxidation stability potential of at least 4.0 V (vs. Li/Li⁺), or at least 4.6 V (vs. Li/Li⁺), or at least 5.0 V (vs. Li/Li⁺) In one embodiment, a soluble vinyl fluoride interpolymer may have an oxidation stability parameter of between about 4.0 and about 5.2 V (vs. Li/Li⁺), or between about 4.6 and about 5.2 V (vs. Li/Li⁺), or between about 5.0 and about 5.2 V (vs. Li/Li⁺). For example, soluble vinyl fluoride interpolymers may be used as a polymer binder in electrodes for lithium-ion batteries where the operating voltage is at least 3.7 V, or at least 4.2 V, or at least 4.7 V, or at least 5.0 V. In one embodiment, a soluble vinyl fluoride interpolymer may be used as a polymer binder in an electrode for a lithium-ion battery where the operating voltage is between about 3.7 V and about 5.1 V, or between about 4.2 V and about 5.1 V, or between about 4.7 V and about 5.1 V. Those skilled in the art will appreciate the wide variety of electrochemical applications where soluble vinyl fluoride interpolymers may be used.

### Test Methods

### Polymer Composition

Polymer composition was determined by 19F-NMR measuring the spectrum at 235.4 MHz of each polymer dissolved in dimethylacetamide at 130° C. Integration of signals near 80 ppm arising from CF₃ groups was used to measure the amount of hexafluoropropylene (HFP) in the polymer. Integration of complex sets of signals from 105 to 135 ppm for CF₂ groups from TFE units in the terpolymer, corrected for the CF₂ content contributed by any other monomer, and from 150 to 220 ppm for CHF groups from the VF units in the terpolymer corrected for the CF content contributed by any other monomer when present provided complete compositional data for each sample. Infrared spectroscopy was used to identify the presence of ionic end groups.

### Glass Transition Temperature and Melting Point

Glass transition temperatures (T_{g}) and melting points (Tₘ) were measured in air using a Q20 Differential Scanning calorimeter (DSC) (TA Instruments, New Castle, Del.). Because the thermal history of the sample can affect the measurement of T_{g} and Tₘ, samples were heated to 250° C. at 10° C./min, then cooled and reheated at 10° C./min. The midpoint of the inflection observed during the heating cycles is reported as T_{g}. The peak temperature of the endotherm observed during the reheat of the sample is reported as Tₘ.

### Heat of Fusion

Heat of fusion of the polymer was determined by integrating the area under the melting endotherm recorded by the DSC and is reported as ΔH_{f} in J/g.

### Capacity Retention and Impedance

All coin cell testing was done at room temperature (25° C.) using a Series 4000 battery tester (MACCOR, Inc., Tulsa, Okla.). Lithium half-cells were subjected to a conventional formation process in which the half-cells were charged at C/10 (15 mA) to a cut-off voltage of 4.3 V and then held potentiostatically at 4.3 V for 4 hours. After the formation process, the first C-rate test of the half-cells was conducted by discharging the cells at different rates (ranging from C/10 to 20 C) to 3.0 V and then holding at 3.0 V for 4 hours.

After the first C-rate test, the leakage current of the cell was measured. Leakage current was measured after holding the cell at 4.3 V and 25° C. for 200 hours. Lower leakage current is believed to correlate with better electrolyte and binder stability. Leakage currents below 1 μA are considered to be good.

After the leakage current measurement, a second C-rate test was conducted using a similar profile as first C-rate test by discharging the cells at different rates (ranging from C/10 to 20 C) to 3.0 V and then holding at 3.0 V for 4 hours.

After the second C-rate test, the capacity retention (specific capacity vs. cycle number) and impedance of the half-cells was measured by cycling at a rate of C/4 for 300 cycles between 3.0 V and 4.25 V.

### Adhesion Testing

Calendared electrode films were placed between sheets of Kapton® polyimide film (E.I. du Pont de Nemours and Co., Wilmington, Del.) in a 90° C. vacuum oven with a vacuum/nitrogen bleed overnight to ensure that they were dry. A Kapton® polyimide tab strip was then placed down the entire length (i.e., edge) of the electrode, covering approximately ⅛″ of the edge of the electrode. Five pieces of tape (Intertape DCP051A polyester tape, 1″wide, Hillas Packaging, Fort Worth, Tex.) were placed transversely across each electrode (i.e., perpendicular to the Kapton® polyimide strip) to make multiple test strips, and rolled with a rubber roller to firmly adhere the tape to the electrodes. The test strips were then placed back in the vacuum oven with a vacuum/nitrogen bleed at room temperature overnight. Adhesion tests were carried out following the procedure of ASTM-D1876 using an Instron® Model 3365 Dual Column Testing System (Instron, Norwood, Mass.).

### EXAMPLES

The concepts described herein will be further described in the following examples, which do not limit the scope of the invention described in the claims.

### Examples 1 to 11 and Comparative Examples 1 and 2

### Synthesis of Soluble Copolymers

A horizontal stainless steel autoclave of 11.3 L (3 US gallons) or 37.8 L (10 US gallons) capacity equipped with a stirrer and a jacket was used as a polymerization reactor. Instruments for measuring temperature and pressure and a compressor for supplying the monomer mixtures to the autoclave at a desired pressure were attached to the autoclave.

The autoclave was filled with deionized water containing perfluoro-2-propoxypropanoic acid (DA) and Krytox® 157FSL (DuPont) neutralized with ammonium hydroxide to reach a pH in the range of about 7-8, to 70 to 80% of its capacity, and was followed by increasing the internal temperature to 90° C. The autoclave was subsequently purged of air by pressurizing three times to 2.8 MPa (400 psig) using nitrogen. After purging, ethane was optionally introduced into the autoclave, which was then precharged with the monomer mixtures until the internal pressure reached 2.8 MPa (400 psig).

An initiator solution was prepared by dissolving 10 g ammonium persulfate (APS) into 1 L of deionized water. When using a 3 gallon reactor, the initiator solution was supplied into the reactor with an initial feed of 25 ml, then fed at the rate of 1 ml/min during the reaction. When using a 10 gallon reactor, the initiator solution was supplied into the reactor with an initial feed of 80 ml, then fed at the rate of 3 ml/min during the reaction. When the internal pressure of the reactor began to drop, makeup monomer mixtures were supplied to keep the pressure constant at 2.8 MPa (400 psig).

The composition of the makeup monomer mixture is different from that of the precharge mixture because of the different reactivity of each monomer. Since each composition is selected so that the monomer composition in the reactor is kept constant, a product having a uniform composition was obtained.

Monomers were supplied to the autoclave until a solid content in the produced latex reached about 20-30%. When the solid content reached a predetermined value, supply of the monomers was immediately stopped, then the contents of the autoclave were cooled and unreacted gases in the autoclave were purged off.

To the resulting latex, 15 g of ammonium carbonate dissolved in water per 1 L of latex and then 70 mL of HFC-4310 (1,1,1,2,3,4,4,5,5,5-decafluoropentane) per 1 L of latex were added while stirring at high speed, followed by isolation of the polymer by filtration. The polymer was washed with water and dried at 90 to 100° C. in a hot-air dryer. Compositions, glass transition temperatures, melting points and heats of fusion of the produced polymers are shown in Table 1. For each example, two measurements were made for the glass transition, melting point and heat of fusion.

Comparative Examples 1 and 2, with VF contents of less than 64 mol % were not soluble in NMP. Examples 1 to 11 were all soluble in NMP.

TABLE 1

| | Polymer Comp | | | | | | | |
|---|---|---|---|---|---|---|---|---|
| Ex- | (mol %) | | | Solids | Polymer | Tg | Tm | ΔHf |
| ample | TFE | VF | HFP | (%) | (g) | (° C.) | (° C.) | (J/g) |
| CE1 | 54.9 | 37.4 | 7.7 | 30.6 | 8322 | 32, 32 | 171, 170 | 21, 18 |
| CE2 | 42.2 | 46.4 | 8.4 | 18.7 | 116.9 | 33, 32 | 174, 156 | 5.7, 6.5 |
| E1 | 20.0 | 73.3 | 6.6 | 16.6 | 1298 | | 149, 146 | |
| E2 | 25.0 | 66.8 | 8.2 | 28.6 | 197.4 | 38, 38 | 152, 149 | 17, 15 |
| E3 | 29.1 | 64.0 | 6.9 | 23.9 | 151.6 | 40, 41 | 165, 168 | 27, 23 |
| E4 | 16.3 | 74.5 | 9.2 | 31.8 | 2608 | 37, 37 | 143, 139 | 11, 11 |
| E5 | 17.9 | 73.6 | 8.5 | 31.1 | 2495 | 37, 37 | 139, 136 | 9, 10 |
| E6 | 15.6 | 74.9 | 9.5 | 30.9 | 2572 | 37, 37 | 139, 136 | 9, 11 |
| E7 | 16.2 | 74.3 | 9.5 | 30.8 | 2546 | 36, 37 | 140, 137 | 10, 11 |
| E8 | 25.1 | 68.2 | 6.8 | 29.6 | 2431 | 40, 41 | 165, 163 | 27, 19 |
| E9 | 25.2 | 68.2 | 6.6 | 29.7 | 2382 | 40, 41 | 155, 148 | 27, 19 |
| E10 | 25.9 | 68.0 | 6.1 | 29.6 | 2468 | 39, 40 | 156, 158 | 26, 19 |
| El 1 | 26.6 | 66.5 | 6.8 | 29.6 | 2451 | 38, 42 | 158, 152 | 27, 18 |

### Examples 12 to 14 and Comparative Examples 3 to 6

### Oxidation Potential Stability—Linear Sweep Voltammetry (LSV)

For Comparative Example 3 (CE3), a polymer binder solution was obtained as a 12% solution of polyvinylidene fluoride in NMP (KH-1100, Kureha America Corp. New York, N.Y.). The polymer binder solution was diluted using NMP to an about 2.5 wt % solution. The solution was dip coated onto a stainless steel (Grade 316) wire and dried at 80° C. overnight to obtain a binder coated electrode. Linear sweep voltammetry was performed in a argon filled dry-box using a standard 3-electrode cell with platinum wire as counter electrode, a silver wire as reference electrode, commercial 1.0 M LiPF₆ electrolyte (Novolyte, Cleveland, Ohio) and a 1 mv/sec sweep rate. From a plot of the current versus voltage, the oxidation stability potential was determined.

For Comparative Example 4, the procedure of CE3 was used, replacing the PVDF binder with a higher molecular weight PVDF binder KH-1700 (Kureha). For Comparative Examples 5 and 6, the PVDF binder of CE3 was replaced with other PVDF binders, Kynar® HSV 900 (Arkema Inc., King of Prussia, Pa.) and Solef® 5130 (Solvay Specialty Polymers, West Deptford, N.J.), respectively.

For Example 12, the procedure of CE3 was used, replacing the PVDF binder with the interpolymer of E1. For Examples 13 and 14, the PVDF binder of CE3 was replaced with the interpolymers of E2 and E3, respectively. As seen in Table 2, vinyl fluoride interpolymers are able to achieve higher oxidation stability potentials depending on the composition used.

TABLE 2

| | Oxidation Stability Potential |
|---|---|
| Example | (V) |
| CE3 | 4.67 |
| CE4 | 4.69 |
| CE5 | 4.60 |
| CE6 | 4.70 |
| E12 | 4.60 |
| E13 | 5.20 |
| E14 | 5.20 |

### Example 15 and Comparative Example 7

### Capacity Retention and Impedance

Electrode precursor compositions were made by first dissolving 5 g of polymer binder in 95 g of NMP to get a 5 wt % polymer binder solution, using vinyl fluoride interpolymer (Example 15, E15) or PVDF (Comparative Examples 7, CE7) as the polymer binder. In a vial, 1.43 g of NMP, 0.59 g of SUPER P™ Li carbon black (TIMCAL Ltd., Bodio, Switzerland), 7.22 g of LiNi_{0.33}Mn_{0.33}CO_{0.33}O₂ (NMC) and 11.76 g of polymer binder solution were added, in that order. The vial was capped, taped and mixed on a THINKY MIXER Planetary Centrifugal Mixer (THINKY USA, Inc., Laguna Hills, Calif.) for 2 min. at 2000 rpm. The electrode precursor composition was homogenized for 1 hour in an ice water bath to keep it cool (additional NMP may be added to improve viscosity), and then mixed again for 2 min. at 2000 rpm to de-gas before casting electrode films. From this electrode precursor composition, electrodes were made having a NMC/carbon/binder composition of 86/7/7 wt %.

To make electrode films, two 6-inch pieces of Al foil were washed with dichloromethane followed by isopropyl alcohol for each electrode composition to be tested. Film casting was done either by auto-caster or by hand using a 5-inch wide #10, or #14, blade to get a nominal 2 mil dry film thickness. The electrode film was dried in an oven by ramping from 30 to 120° C. over 60 min., followed by cooling down to 30° C. in the oven and further cooling in a hood for 30 min. Each electrode film was then calendared, sandwiched between Kapton® polyimide sheets and brass sheets (the Kapton® polyimide sheets protecting the electrode from the brass sheets), running 1 pass at 9 psi, then 1 pass at 12 psi, and finally 1 pass at 15 psi.

From the calendared electrode films, ½″ diameter coin cell electrodes were punched out and dried overnight under vacuum at 90° C. These electrodes were then used in a lithium half-cell configuration with a Li anode and ethylene carbonate (EC)/ethylmethyl carbonate (EMC) electrolyte (Novolyte Technologies, Cleveland, Ohio). Three lithium half-cells were made to measure the capacity retention and impedance for both E15 and CE7 which is summarized in Tables 3 and 4 as an average of the three cells of each.

TABLE 3

| | | Capacity Retention | | |
|---|---|---|---|---|
| Example | Polymer Binder | 100 Cycles | 200 Cycles | 300 Cycles |
| CE7 | PVDF | 94.9% | 90.4% | 85.1% |
| E15 | VF interpolymer | 94.8% | 89.5% | 85.9% |

TABLE 4

| | | Impedance (1000 Hz) | | | | |
|---|---|---|---|---|---|---|
| | | 0 | 50 | 100 | 200 | 300 |
| Example | Polymer Binder | Cylces | Cycles | Cycles | Cycles | Cycles |
| CE7 | PVDF | 0.20 | 0.20 | 0.21 | 0.23 | 0.30 |
| E15 | VF interpolymer | 0.21 | 0.21 | 0.22 | 0.24 | 0.28 |

E15 demonstrates that vinyl fluoride interpolymer has comparable life cycle capacity retention and comparable to slightly better impedance growth compared to PVDF.

### Examples 16 to 18 and Comparative Examples 8 to 10

### Adhesion

For Examples 16 to 18 (E16-E18) using vinyl fluoride interpolymer and Comparative Examples 8 to 10 (CE8-CE10) using PVDF, electrodes were prepared as above, but with NMC/carbon/binder compositions of 90/5/5 wt % (E16 and CE8), 94/3/3 wt % (E17 and CE9) and 98/1/1 wt % (E18 and CE10). Table 5 summarized the adhesion of electrodes, comparing vinyl fluoride interpolymer with PVDF at different polymer binder loadings.

TABLE 5

| Example | Polymer Binder | Wt % Binder | Adhesion (lb/in) |
|---|---|---|---|
| CE8 | PVDF | 1 | 0 |
| E16 | VF interpolymer | 1 | 0.35 |
| CE9 | PVDF | 3 | 0.12 |
| E17 | VF interpolymer | 3 | 1.58 |
| CE10 | PVDF | 5 | 0.91 |
| E18 | VF interpolymer | 5 | 1.91 |

E16-E18 demonstrate that electrodes using vinyl fluoride interpolymer as a polymer binder have far superior adhesion to Kapton® polyimide film compared to PVDF.

Note that not all of the activities described above in the general description or the examples are required, that a portion of a specific activity may not be required, and one or more further activities may be performed in addition to those described. Still further, the order in which activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that one or more modifications or one or more other changes can be made without departing from the scope of the invention as set forth in the claims below. Accordingly, the specification and figures are to be regarded in an illustrative rather than a restrictive sense and any and all such modifications and other changes are intended to be included within the scope of invention.

Any one or more benefits, one or more other advantages, one or more solutions to one or more problems, or any combination thereof has been described above with regard to one or more specific embodiments. However, the benefit(s), advantage(s), solution(s) to problem(s), or any element(s) that may cause any benefit, advantage, or solution to occur or become more pronounced is not to be construed as a critical, required, or essential feature or element of any or all of the claims.

It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any sub-combination. Further, reference to values stated in ranges include each and every value within that range.

What is claimed is:

1. An electrode composition comprising:
an electroactive material; and
an interpolymer comprising polymer units derived from about 64 to about 75 mole percent vinyl fluoride and from about 25 to about 36 mole percent of at least two highly fluorinated monomers, wherein a first highly fluorinated monomer provides the interpolymer a side chain of at least one carbon atom.

2. The electrode composition of claim 1, wherein a second highly fluorinated monomer comprises a C₂ olefin.

3. The electrode composition of claim 1, wherein the first highly fluorinated monomer comprises hexafluoropropylene.

4. The electrode composition of claim 2, wherein the C₂ olefin is selected from the group consisting of vinylidene fluoride, tetrafluoroethylene, trifluoroethylene, and chlorotrifluoroethylene.

5. The electrode composition of claim 4, wherein the C₂ olefin comprises tetrafluoroethylene.

6. The electrode composition of claim 1, wherein the interpolymer comprises from about 6 to about 10 mole percent of the first highly fluorinated monomer.

7. The electrode composition of claim 2, wherein the interpolymer comprises less than about 30 mole percent of the second highly fluorinated monomer.

8. The electrode composition of claim 1, wherein the electroactive material comprises an electroactive cathode material.

9. The electrode composition of claim 1, wherein the electroactive material comprises an electroactive anode material.

10. The electrode composition of claim 1, further comprising a conductive additive material.

11. The electrode composition of claim 1, wherein the electrode composition comprises less than 10 weight percent interpolymer.

12. The electrode composition of claim 1, further comprising polyvinylidene fluoride.

13. An energy storage device comprising:
an anode;
a cathode;
a porous separator between the anode and the cathode; and
an electrolyte, wherein the anode, the cathode or both the anode and the cathode comprise a binder material comprising an interpolymer comprising polymer units derived from about 64 to about 75 mole percent vinyl fluoride and from about 25 to about 36 mole percent of at least two highly fluorinated monomers, wherein a first highly fluorinated monomer provides the interpolymer a side chain of at least one carbon atom.

14. The energy storage device of claim 13, wherein a second highly fluorinated monomer comprises a C₂ olefin.

15. The energy storage device of claim 13, wherein the first highly fluorinated monomer comprises hexafluoropropylene.

16. The energy storage device of claim 14, wherein the C₂ olefin is selected from the group consisting of vinylidene fluoride, tetrafluoroethylene, trifluoroethylene, and chlorotrifluoroethylene.

17. The energy storage device of claim 16, wherein the C₂ olefin comprises tetrafluoroethylene.

18. The energy storage device of claim 13, wherein the energy storage device operates at a voltage of at least 3.7 volts.

19. The energy storage device of claim 18, wherein the energy storage device operates at a voltage of at least 4.2 volts.

20. The energy storage device of claim 19, wherein the energy storage device operates at a voltage of at least 4.7 volts.

21. The energy storage device of claim 13, wherein the energy storage device comprises a lithium-ion battery.
